(19) United States
(12) Patent Application Publication
(10) Pub. No.: US 2018/0372020 A1
(43) Pub. Date: Dec. 27, 2018

(54) Piston For An Internal Combustion Engine and Production Method Therefore

(71) Applicant: KS Kolbenschmidt GmbH, Neckarsulm (DE)

(72) Inventors: Robert Kühnel, Erfurt BiiBleben (DE); Gerson Hartwig, Neckarsulm (DE); Andreas Rehl, Heilbronn (DE)

(21) Appl. No.: 16/117,769

(22) Filed: Aug. 30, 2018

Related U.S. Application Data
(63) Continuation of application No. 15/028,960, filed on Apr. 13, 2016, now abandoned.

(30) Foreign Application Priority Data
Oct. 14, 2013 (DE) 102013220741.7

(51) Int. Cl. F02F 3/02; F16J 1/00; F02F 3/00

(52) U.S. Cl. CPC F02F 3/022; F02F 3/02; F02F 2200/04; F02F 3/003; F02F 2200/06; F16J 1/00

(57) ABSTRACT

A piston of an internal combustion engine having a piston head which has a ring zone and is adjoined by a piston skirt which encloses an inner shape, with two box walls which lie opposite one another and are set back with respect to the outer contour of the piston and with two skirt walls which are not set back with respect to the outer contour of the piston, wherein the box walls receive hubs, wherein the piston skirt has skirt supports which are connected to the hub, wherein the width of the box wall is a point of intersection between the pin axis and the constant-curvature and constant-tangent further course of the box wall, and to a method for producing a piston for internal combustion engines.

### CROSS-REFERENCE TO RELATED APPLICATIONS

This continuation application claims priority benefit to U.S. patent application Ser. No. 15/028,960 filed Apr. 13, 2016 the entire contents of which is incorporated herein by reference

### TECHNICAL FIELD

The invention relates to a piston for an internal combustion engine and to a production method in accordance with the features of the respective preambles of the independent patent claims.

### BACKGROUND

DE 10 2009 059 056 A1 relates to a piston for an internal combustion engine, with a piston head, a circumferential firing land and a circumferential ring belt which has ring grooves, and with a piston skirt which has two skirt walls and two box walls which connect the skirt walls and are set back with respect to the ring belt, in such a way that in each case one free-standing underside of the ring belt is formed in the region of the box walls, the box walls being provided with pin bosses which have pin bores. It is provided that at least one supporting element is arranged between each free-standing underside of the ring belt and the box wall which is assigned to it. Said supporting elements form an oblique support of the skirt in the boss, which oblique support is complicated to produce.

DE 10 2007 018 932 A1 relates to a piston of an internal combustion engine with a piston head which has a ring zone and is adjoined by a piston skirt which encloses a piston interior space with two load-bearing skirt wall sections and two pin bosses. Each pin boss which encloses a pin bore is connected to a boss main body via a boss support. DE 10 2007 018 932 A1 is therefore one example of existing piston geometries which have a skirt which is set back in the pin axis direction in the manner of a box-type piston. In this design, a great wall thickness and therefore a high use of material are necessary, in order to ensure low deformation as a result of the loads which are produced during operation.

In said known box-type pistons of this type, the problem occurs that forces act on the piston during operation of the internal combustion engine as a result of the gas pressure and the ignition pressure, which forces are so great that deformations on the piston can occur. It is particularly disadvantageous here that the ring zone is supported only in the region of the skirt walls, but there is a free-standing, overhanging underside in the region of the box walls. As a consequence, the ring zone can be deformed considerably in the direction of the crankcase in the region of the box walls. In contrast, the ring zone in the region of the skirt walls is deformed only slightly as a consequence of the rigid construction of the box walls and the skirt walls. There is therefore a jump in rigidity in the region, in which the box walls merge into the skirt walls. As a result of this and as a result of the bending moment which occurs during the deformation of the ring zone in the region of the box walls, stresses occur, by way of which the box-type piston is loaded excessively.

### SUMMARY

It is an object of the invention to simplify the production of a piston and to reduce the mass of the piston with increased stability.

This object is achieved by way of a piston and a method having the features of the independent patent claims.

The solution according to the invention consists in that a piston of an internal combustion engine having a piston head which has a ring zone and is adjoined by a piston skirt which encloses an internal shape, with two box walls which lie opposite one another and are set back with respect to the outer contour of the piston and with two skirt walls which are not set back with respect to the outer contour of the piston, the box walls receiving bosses, the piston skirt having skirt supports which are connected to the boss, the width of the box wall being a point of intersection between the pin axis and the continuation with a constant curvature and tangent of the box wall.

It has emerged surprisingly that material and therefore piston mass can be saved by way of the provision of the width of the box wall as a point of intersection between the pin axis and the continuation with a constant curvature and tangent of the box wall. As a result of the design according to the invention of the box walls, the material thickness of the box walls and of the skirt walls can be reduced in comparison with previously known pistons of this design with increased stability.

It is provided in one development of the invention that the skirt support has a concave shape, in relation to the plane which lies through a piston stroke axis and perpendicularly with respect to the pin axis.

Greater stability is achieved as a result of the concave shape of the skirt wall support. The entire piston, in particular in the region of a cantilevered ring zone, therefore becomes more dimensionally stable.

It is provided in one development of the invention that the direction of the skirt support is described by the points of intersection a2i, a3i, a2a, a3a, the points a2i, a2a being the points of intersection between the continuation with a constant curvature and tangent of the box wall and the outer boss radius r which is situated at the level of the pin axis, and the points a3i, a3a being the points of intersection between the continuation with a constant curvature and tangent of the box wall and the continuation with a constant tangent of an internal shape.

It is provided in one development of the invention that the following geometric properties apply:

The ratio of a2i to a3i is from 1.05 to 1.5 (a2i/a3i=from 1.05 to 1.5)

and the ratio of a2a to a3a is from 1.05 to 1.5 (a2a/a3a=from 1.05 to 1.5).

It is provided in one development of the invention that the skirt support is to be of identical configuration for the pressure side and counterpressure side or is varied for the respective side of the piston in the ratios a2i/a3i and a2a/a3a.

It is provided in one development of the invention that the width b of the box wall is defined as follows:

b=((a1+A))/2±15% dₖ.

A method for producing a piston for internal combustion engines, the piston being produced using the casting or forging process, is in accordance with the invention.

According to the invention, the piston is produced using the casting or forging process. The shaping according to the invention of the piston makes simple production using the casting or forging process possible.

In other words, a piston for an internal combustion engine is provided according to the invention, which piston has a piston skirt with bosses for receiving the gudgeon pin which connects the piston to the connecting rod, and skirt supports which are connected to the boss.

It is an object to achieve a design of the piston skirt support on the piston boss which is optimized in terms of structure, weight and friction. Here, the skirt support has a concave shape, in relation to the plane which lies through the piston stroke axis and perpendicularly with respect to the pin axis.

The skirt support is to be of identical configuration for the pressure side and counterpressure side or can be varied for the respective piston side.

### BRIEF DESCRIPTION OF THE DRAWINGS

The invention will be clarified further using the FIGURE which is described in the following text and in which:

FIG. 1 shows a cross section through an example piston 1 having a piston skirt 2 with a skirt support 3.

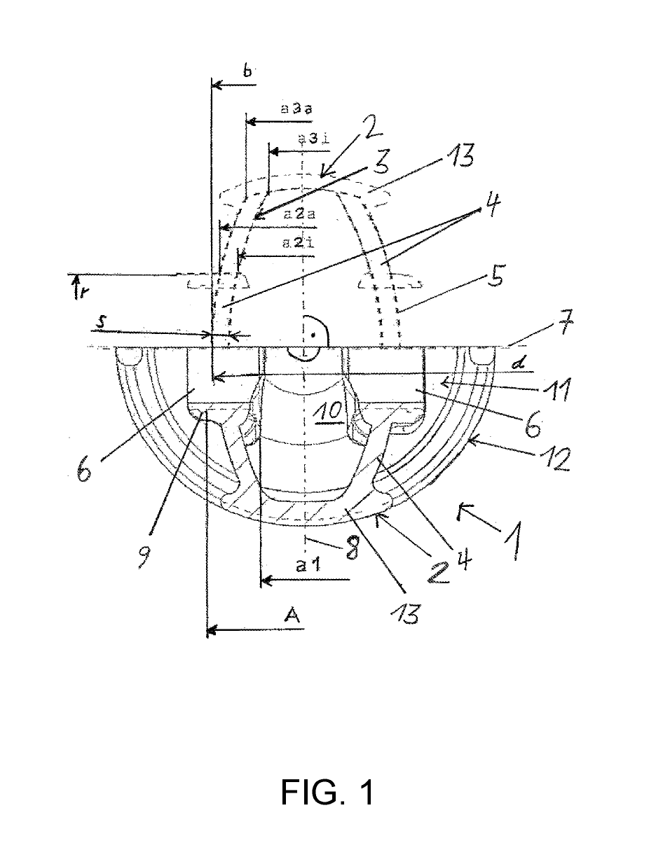

### DETAILED DESCRIPTION OF THE EMBODIMENTS

In the piston 1, two walls of the piston skirt 2 which lie opposite one another are provided such that they are set back with respect to the outer contour of the piston 1. The walls which are set back are called box walls 4; the two other walls which are not set back are called skirt walls 13 and have the actual running surface of the piston skirt 2. Bosses 6 with pin bores are integrated into the box walls 4. The box walls 4 and the skirt walls 13 are connected to the underside of a piston head 11.

The box wall 4 has a width b, a diameter d and a wall thickness s. Furthermore, the piston 1 has a box wall arc 5. In addition, the bosses 6 are penetrated by a pin axis 7. The skirt support 3 has a concave shape in relation to the plane which lies through a piston stroke axis 8 and perpendicularly with respect to the pin axis 7. r denotes the outer boss radius. A describes the axial spacing in the pin direction of the securing ring groove 9, and a1 describes the axial spacing of the start of the load-bearing length in the direction of the pin axis 7.

The points a2a and a2i form points of intersection between the continuation with a constant curvature and tangent of the box wall 4 and the outer boss radius r which is situated at the level of the pin axis 7. The points a3a and a3i form points of intersection between the continuation with a constant curvature and tangent of the box wall 4 and the tangential continuation of the internal shape 10. The internal shape 10 forms part of the underside of the piston head 11. A circumferential ring zone 12 is arranged on the outer circumference of the piston head 11. The ring zone 12 is given support, in particular, by way of the skirt walls 13.

The piston 1 has the following features. The width b of the box wall 4 is the point of intersection between the pin axis 7 and the continuation with a constant curvature and tangent of the box wall 4, and is defined as follows:

b_{box}_{_}_{wall}=((a1+A))/2±15%dₖ,

wherein dₖ describes the piston diameter, A describes the axial spacing in the pin direction of the securing ring groove 9, and a1 describes the axial spacing of the start of the load-bearing length in the direction of the pin axis 7.

The width b of the box wall 4 is equal to the point of intersection of the box wall arc 5 and the pin axis 7.

The direction of the skirt support 3 is described by the points a2i, a3i, a2a and a3a, the points a2i and a2a being the points of intersection between the continuation with a constant curvature and tangent of the box wall 4 and the outer boss radius r which is situated at the level of the pin axis 7, and the points a3i and a3a being the points of intersection between the continuation with a constant curvature and tangent of the box wall 4 and the continuation with a constant tangent of an internal shape 10.

The following geometric properties apply:

a2i/a3i=1.05 . . . 1.5, and
a2a/a3a=1.05 . . . 1.5.

A minimum radius of Rₘᵢₙ≥0.9 dₖ applies here.

All radius combinations (splines, changing radii, combinations of straight lines and radii) in the abovementioned range are included in the present invention.

The skirt support 3 is to be of identical configuration for the pressure side and counterpressure side or can be varied for the respective piston side in the ratios a2i/a3i and a2a/a3a.

### LIST OF DESIGNATIONS

1 Piston
2 Piston skirt
3 Skirt support
4 Box wall
5 Box wall arc
6 Boss
7 Pin axis
8 Piston stroke axis
9 Securing groove
10 Internal shape
11 Piston head
12 Ring zone
13 Skirt wall
A Axial spacing of the securing ring groove in the pin axis direction
a1 Axial spacing of the start of the load-bearing length in the pin axis direction
a2a Point of intersection between the continuation with a constant curvature and tangent of the box wall and the outer boss radius which is situated at the pin axis level
a2i Point of intersection between the continuation with a constant curvature and tangent of the box wall and the outer boss radius which is situated at the pin axis level
a3a Point of intersection between the continuation with a constant curvature and tangent of the box wall and the tangential continuation of the internal shape
a3i Point of intersection between the continuation with a constant curvature and tangent of the box wall and the tangential continuation of the internal shape
b Width of the box wall
d Diameter of the box wall
dₖ Piston diameter
r Outer boss radius
s Wall thickness
Rₘᵢₙ Radius

1-9. (canceled)

10. A piston of an internal combustion engine having a piston head which has a ring zone and is adjoined by a piston skirt which encloses an internal shape, with two box walls which lie opposite one another and are set back with respect to the outer contour of the piston and with two skirt walls which are not set back with respect to the outer contour of the piston, the box walls receiving bosses, the piston skirt having skirt supports which are connected to the boss, characterized in that the width (b) of the box wall is a point of intersection between a pin axis and a continuation with a constant curvature and tangent of the box wall;
wherein the direction of the skirt support is described by points of intersection (a2i, a3i, a2a, a3a), the points (a2i, a2a) being points of intersection between the continuation with the constant curvature and tangent of the box wall and the outer boss radius (r) which is situated at the level of the pin axis, and the points (a3i, a3a) being the points of intersection between the continuation with the constant curvature and tangent of the box wall and the continuation with a constant tangent of an internal shape;
wherein the following geometric properties apply to the piston:
a2i/a3i=from 1.05 to 1.5
and
a2a/a3a=from 1.05 to 1.5.

11. The piston of claim 10 characterized in that the skirt support has a concave shape, in relation to the plane which lies through a piston stroke axis and perpendicularly with respect to the pin axis.

12. The piston of claim 10, characterized in that the skirt support is to be of identical configuration for a pressure side and a counterpressure side or is varied for the respective side of the piston in the geometric properties ratios a2i/a3i and a2a/a3a.

13. The piston of claim 12 characterized in that the width (b) of the box wall (4) is defined as follows:
b=((a1+A))/2±15% dₖ.

14. The piston of claim 10 characterized in that the width (b) of the box wall is defined as follows:
b=((a1+A))/2±15% dₖ.

15. A method for producing a piston according to claim 10, wherein the piston is produced using a casting or a forging process.
